(19) United States
(12) Patent Application Publication
(10) Pub. No.: US 2026/0070529 A1
(43) Pub. Date: Mar. 12, 2026

(54) HYDRAULIC UNIT FOR BRAKE SYSTEM

(71) Applicant: HL MANDO CORPORATION, Pyeongtaek-si (KR)

(72) Inventor: Seunghwan BYUN, Pyeongtaek-si (KR)

(73) Assignee: HL MANDO CORPORATION, Pyeongtaek-si (KR)

(21) Appl. No.: 18/986,949

(22) Filed: Dec. 19, 2024

(30) Foreign Application Priority Data
Sep. 12, 2024 (KR) 10-2024-0124688

(51) Int. Cl. B60T 13/14; B60T 7/04; B60T 13/68; B60T 13/74; B60T 17/04; B60T 17/06

(52) U.S. Cl. CPC B60T 13/142; B60T 7/042; B60T 13/148; B60T 13/686; B60T 13/745; B60T 17/043; B60T 17/06; B60T 2220/04; B60T 2270/82

(57) ABSTRACT

Disclosed is a hydraulic unit for a brake system. A hydraulic unit according to the present embodiment may include a main reservoir tank, a hydraulic block having a reservoir bore, a cylinder bore, a motor bore, a hydraulic flow path, and a valve bore, and an electronic control unit, in which the motor bore is provided on a first surface of the hydraulic block, in which a housing of the electronic control unit is provided on a second surface of the hydraulic block, in which the main reservoir tank includes a coupling part, an extension part, and a connection part.

### CROSS-REFERENCE TO RELATED APPLICATIONS

This application claims the priority of Korean Patent Application No. 10-2024-0124688 filed on Sep. 12, 2024, in the Korean Intellectual Property Office, the disclosure of which is incorporated herein by reference.

### BACKGROUND

### Field

The present disclosure relates to a hydraulic unit for a brake system, and more particularly, to a hydraulic unit for a brake system that generates a braking force by using an electrical signal corresponding to a displacement of a brake pedal.

### Description of the Related Art

A vehicle is essentially equipped with a brake system for braking the vehicle. Various types of brake systems have been proposed to provide safety for a driver and a passenger.

The brake system in the related art mainly operates in such a way that when the driver pushes a brake pedal, a booster mechanically connected to the brake pedal is used to supply a wheel cylinder with a liquid pressure required to brake the vehicle. However, as there is an increasing demand from the market to implement various braking functions in order to appropriately cope with operational environments of vehicles, integrated dynamic brakes (IDBs) have recently widely proliferated, in which when a driver pushes a brake pedal, a pedal displacement sensor, which detects a displacement of the brake pedal, transmits an electrical signal to indicate a driver's intention to brake, and a liquid pressure supply device operates in response to the electrical signal to supply a wheel cylinder with a liquid pressure required to brake the vehicle.

An integrated brake system may generate a stable, strong braking force by integrating a master booster and an electronic stability control (ESC) device. In general, the integrated brake system includes a configuration in which a pedal displacement sensor operates a motor by outputting an operation of a brake pedal as an electrical signal, a piston pump of a liquid pressure generation device generates hydraulic braking pressure in accordance with an operation of the motor, and an electronic control unit controls the hydraulic pressure and transmits the hydraulic pressure to wheels. In addition, a master cylinder is provided in a hydraulic block equipped with a hydraulic circuit to transmit a pedal effort of a brake pedal directly to a wheel cylinder when the system operates abnormally.

There is provided a reservoir that provides a pressurized medium, such as brake oil, to the integrated brake system to perform a braking operation by means of the integrated brake system described above. Typically, the reservoir stores the pressurized medium therein and is coupled to an upper portion of the master cylinder. In addition, the reservoir may be connected to the piston pump so that the piston pump provided in the liquid pressure generation device of the integrated brake system generates liquid pressure.

The reservoir is installed in various ways to supply the pressurized medium to the integrated brake system. However, there is a problem in that it is difficult to install the reservoir in a limited space in the vehicle.

In addition, there is a problem in that an oil port of the reservoir, through which the pressurized medium is introduced or discharged, is exposed to air under vehicle traveling conditions and some braking conditions, and air is introduced into the brake system, which degrades pedal feel and brake performance.

### SUMMARY

An object to be achieved by the present embodiment is to provide a hydraulic unit for a brake system capable of easily implementing installation and arrangement of a vehicle.

Another object to be achieved by the present embodiment is to provide a hydraulic unit for a brake system capable of being provided to have a compact size while performing various functions.

Still another object to be achieved by the present embodiment is to provide a hydraulic unit for a brake system capable of improving a degree of design freedom and spatial utilization of a vehicle.

Yet another object to be achieved by the present embodiment is to provide a hydraulic unit for a brake system capable of ensuring durability and operational stability of devices by preventing interference with peripheral component elements.

Still yet another object to be achieved by the present embodiment is to provide a hydraulic unit for a brake system capable of effectively preventing air from being introduced into a brake system.

Another further object to be achieved by the present embodiment is to provide a hydraulic unit for a brake system capable of preventing pedal feel and brake performance from deteriorating.

One aspect of the present disclosure provides a hydraulic unit including: a main reservoir tank configured to accommodate a pressurized medium; a hydraulic block having a reservoir bore configured to communicate with the main reservoir tank, a cylinder bore in which a master cylinder connected to a brake pedal is provided, a motor bore in which a motor configured to generate liquid pressure by being operated by an electrical signal outputted in response to a displacement of the brake pedal is provided, a hydraulic flow path, and a valve bore in which a valve configured to control a flow of the pressurized medium through the hydraulic flow path is provided; and an electronic control unit configured to control operations of the motor and the valve on the basis of information on the displacement of the brake pedal, in which the motor bore is provided on a first surface of the hydraulic block, in which a housing of the electronic control unit is provided on a second surface of the hydraulic block that is a surface opposite to the first surface, in which the main reservoir tank includes: a coupling part provided on a third surface that defines a front side surface between the first surface and the second surface; an extension part provided in a direction corresponding to a longitudinal direction of the housing; and a connection part configured to allow the coupling part and the extension part to communicate with each other, and is provided to surround a front side surface of the housing.

The coupling part may include: a first fastening portion coupled to the third surface of the hydraulic block; a second fastening portion coupled to a fourth surface that defines an upper surface between the first surface and the second surface of the hydraulic block; and a tank portion provided between the first fastening portion and the second fastening portion.

The extension part may be provided to be spaced apart from the housing at a predetermined interval.

The connection part may be provided to be spaced apart from the front side surface of the housing at a predetermined interval.

The main reservoir tank may be formed by coupling a main upper body and a main lower body.

The hydraulic unit may further include: a remote reservoir tank configured to store the pressurized medium therein, in which the main upper body includes a first connection port configured to receive the pressurized medium from the remote reservoir tank.

An upper surface of the main upper body may include first and second sections respectively formed to be inclined toward two opposite ends based on the first connection port.

The first section may have a first inclination angle so that air is discharged from one end of the main upper body to the first connection port, and the second section may have a second inclination angle so that air is discharged from the other end of the main upper body to the first connection port.

The first connection port may be provided to be inclined upward based on a lower surface of the main upper body.

The main lower body may include a plurality of oil ports coupled to the third surface of the hydraulic block and configured to supply the pressurized medium.

The remote reservoir tank may include: an injection part configured to inject the pressurized medium; and a second connection port configured to supply the pressurized medium to the main reservoir tank, and the pressurized medium may be stored in the remote reservoir tank.

The hydraulic unit may further include: a connection member configured to connect the first connection port and the second connection port so that the pressurized medium in the remote reservoir tank is transferred to the main reservoir tank.

The main reservoir tank may include: a main reservoir chamber configured to store the pressurized medium therein; and at least one partition wall provided to divide the main reservoir chamber into a plurality of chambers.

The main lower body may include an accommodation portion configured to accommodate a detection part configured to detect a level of the pressurized medium accommodated in the main reservoir chamber, and a warning lamp light switch provided to raise a warning to a driver on the basis of a signal detected by the detection part.

The reservoir bore may be provided in the third surface of the hydraulic block.

The cylinder bore may be provided in a fifth surface of the hydraulic block that defines a rear side surface between the first surface and the second surface.

The valve bore may be provided in the second surface of the hydraulic block.

The electronic control unit may include a connector configured to supply power to a circuit board or transmit an electrical signal, and the connector may be positioned at an upper side of a fourth surface of the hydraulic block that defines an upper surface between the first surface and the second surface.

Another aspect of the present disclosure provides a hydraulic unit including: a master cylinder connected to a brake pedal; a hydraulic block having a plurality of hydraulic flow paths and configured such that the master cylinder is mounted on the hydraulic block; an electronic control unit installed on a side surface of the hydraulic block and configured to control operations of a motor and a valve mounted on the hydraulic block; and a main reservoir tank mounted on a front surface of the hydraulic block and having a ‘ [symbol] ’ shape formed to surround the electronic control unit, in which the main reservoir tank accommodates a pressurized medium therein and includes a plurality of chambers separated by a plurality of partition walls.

A brake system including any one of the hydraulic units may be provided.

The hydraulic unit for a brake system according to the present embodiment may easily implement the installation and arrangement of the vehicle.

The hydraulic unit for a brake system according to the present embodiment may be provided to have a compact size while performing various functions.

The hydraulic unit for a brake system according to the present embodiment may improve the degree of design freedom and spatial utilization of the vehicle.

The hydraulic unit for a brake system according to the present embodiment may ensure the durability and operational stability of the devices by preventing interference with peripheral component elements.

The hydraulic unit for a brake system according to the present embodiment may effectively prevent air from being introduced into the brake system.

The hydraulic unit for a brake system according to the present embodiment may prevent the pedal feel and brake performance from deteriorating.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating a hydraulic unit according to the present embodiment;

FIG. 2 is a side view illustrating the hydraulic unit according to the present embodiment;

FIG. 3 is a top plan view illustrating the hydraulic unit according to the present embodiment;

FIG. 4 is a side view (front side view) illustrating the hydraulic unit according to the present embodiment when viewed in another direction;

FIG. 5 is a perspective view illustrating a main reservoir tank according to the present embodiment;

FIG. 6 is a side view illustrating the main reservoir tank according to the present embodiment;

FIG. 7 is a front view illustrating the main reservoir tank according to the present embodiment;

FIG. 8 is a view illustrating a structure in which the main reservoir tank according to the present embodiment is connected to a remote reservoir tank; and

FIG. 9 is a perspective view illustrating a hydraulic block according to the present embodiment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, embodiments of the present disclosure will be described in detail with reference to the accompanying drawings. The following embodiments are presented to sufficiently provide the spirit of the present disclosure to those skilled in the art to which the present disclosure pertains. The present disclosure is not limited to the embodiments presented herein and may be specified as other aspects. The constituent elements irrelevant to the description of the present disclosure will be omitted from the drawings to clearly describe the present disclosure. The sizes of the constituent elements may be somewhat exaggerated for purposes of understanding.

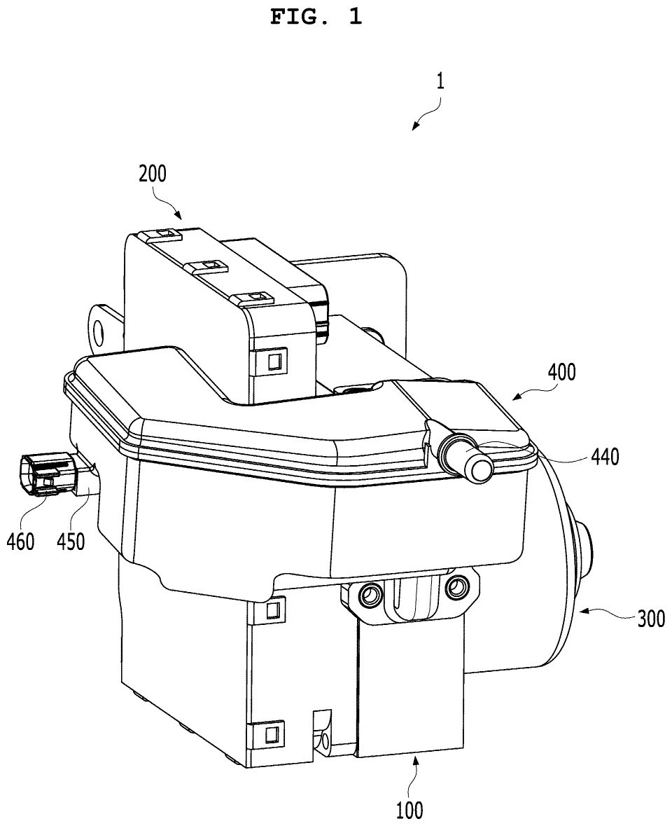

FIG. 1 is a perspective view illustrating a hydraulic unit according to the present embodiment.

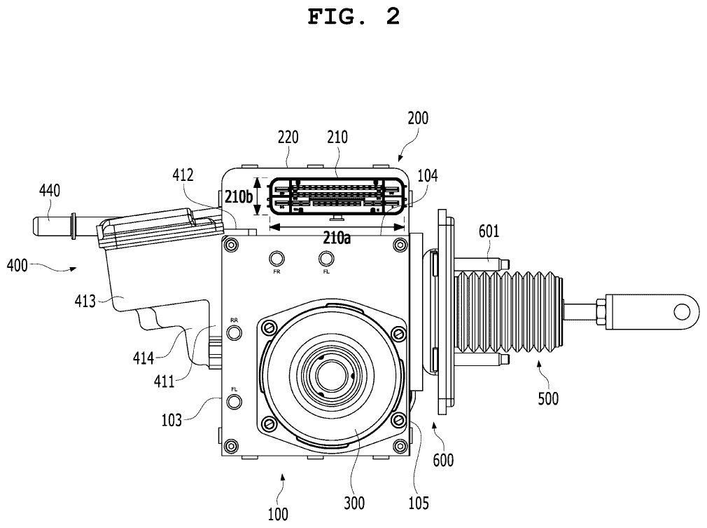

FIG. 2 is a side view illustrating the hydraulic unit according to the present embodiment.

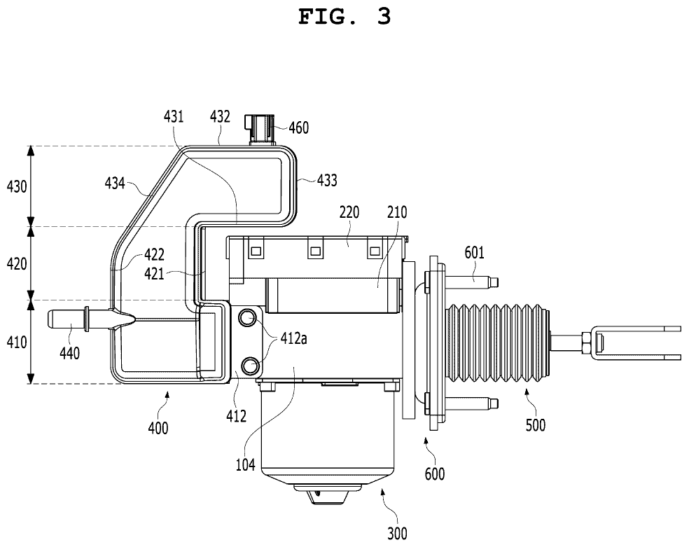

FIG. 3 is a top plan view illustrating the hydraulic unit according to the present embodiment.

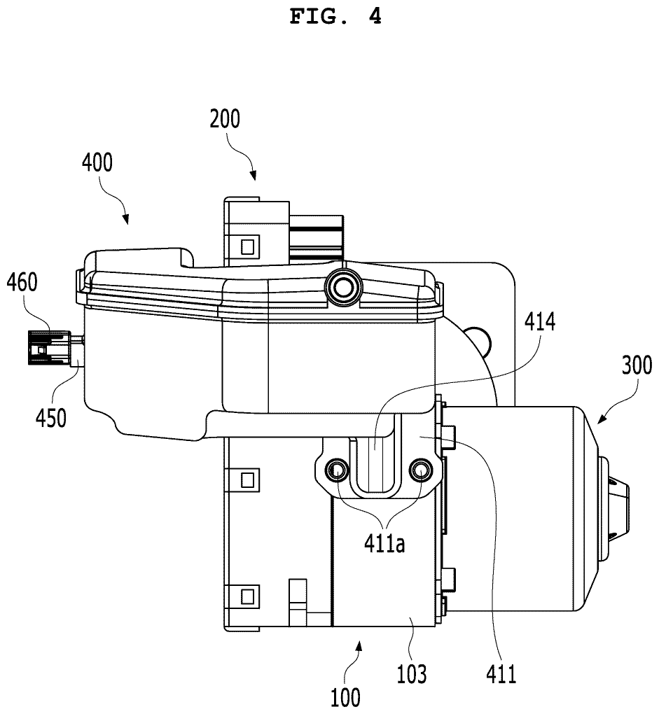

FIG. 4 is a side view (front side view) illustrating the hydraulic unit according to the present embodiment when viewed in another direction.

With reference to FIGS. 1 to 4, a hydraulic unit 1 according to the present embodiment may include a master cylinder 500 connected to a brake pedal (not illustrated), a hydraulic block 100 having a plurality of hydraulic flow paths (not illustrated) and a plurality of bores, an electronic control unit 200 configured to control operations of a motor 300 and a valve mounted on the hydraulic block 100, and a main reservoir tank 400 configured to accommodate a pressurized medium.

The hydraulic block 100 may be provided in a hexahedral shape, the plurality of hydraulic flow paths may be provided in the hydraulic block 100 and define movement routes for the pressurized medium, the plurality of bores may be provided in an outer portion of hydraulic block 100, and various types of component elements, such as the master cylinder 500 and the motor 300, may be mounted in the plurality of bores.

Specifically, the hydraulic block 100 includes a cylinder bore in which the master cylinder 500 connected to the brake pedal and configured to operate in accordance with an operation of the brake pedal is provided, a motor bore 111 in which the motor 300 configured to generate liquid pressure of the pressurized medium, which is required for the braking operation, by being operated by an electrical signal outputted in response to a displacement of the brake pedal is provided, valve bores in which a plurality of valves configured to control the flow of the pressurized medium through the hydraulic flow paths is provided, reservoir bores 112 configured to communicate with the main reservoir tank 400 configured to accommodate the pressurized medium, and wheel ports 113 respectively connected to a plurality of wheel cylinders.

The upper side, the lower side, the front side, and the rear side described hereinafter respectively refer to the front side, the lower side, the left side, and the lower side based on FIG. 2. The thickness direction and the longitudinal direction refer to the upward/downward direction and the leftward/rightward direction based on FIG. 3. These terms are provided to assist in understanding the present disclosure and need to be understood as relative concepts for clearly setting positions and directions without being limited to particular directions or particular sites.

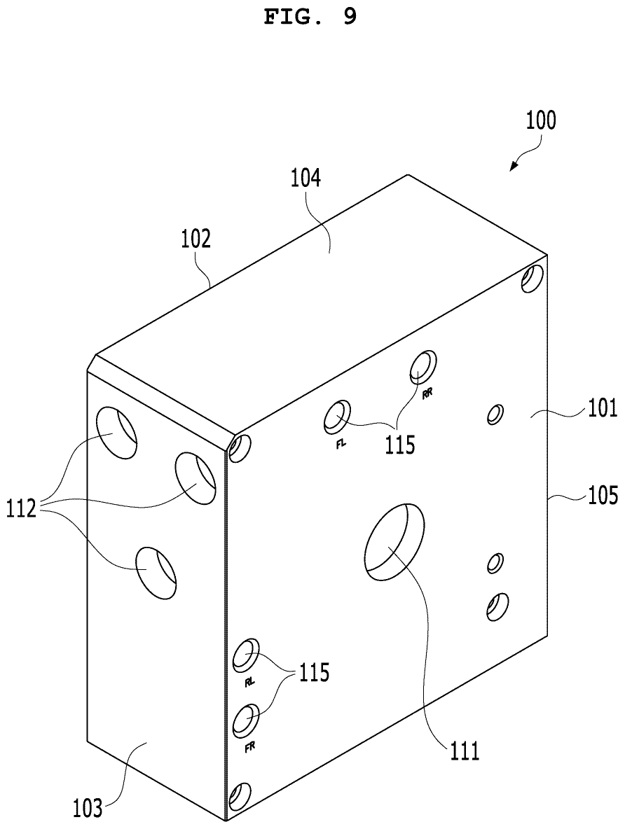

FIG. 9 is a perspective view illustrating the hydraulic block 100 according to the present embodiment. With reference to FIGS. 1 to 4 and 9, the motor bore 111 may be provided in a first surface 101 of the hydraulic block 100 that has a relatively large area, and a housing 230 of the electronic control unit 200 may be provided on a second surface 102 that has a relatively large area and is a surface opposite to the first surface 101. The valve bores, in which the plurality of valves is provided, may also be provided in the second surface 102 and electrically connected to the electronic control unit 200 mounted on the second surface 102.

The motor bore 111 and the valve bore may be recessed in the hydraulic block 100 and extend in the direction parallel to the direction of the thickness between the first surface 101 and the second surface 102. A hydraulic piston (not illustrated), which is operated by the motor 300, may be inserted into the motor bore 111 and reciprocate. The valve bore may also be recessed in the second surface 102 in the same axial direction as the motor bore 111. Various types of solenoid valves and check valves, which control the flow of the pressurized medium flowing along the hydraulic flow paths, may be inserted and mounted into the valve bores.

Reservoir bores 112 may be formed in a third surface 103 of the hydraulic block 100 that defines a front side surface between the first surface 101 and the second surface 102. In case that the reservoir bore 112 is provided in an upper surface of the hydraulic block 100, the size of the product in the upward/downward direction may increase because the main reservoir tank 400 is provided at an upper side of the hydraulic block 100. Therefore, in the hydraulic block 100 according to the present embodiment, the reservoir bore 112, which communicates with the main reservoir tank 400, is provided in the third surface 103, i.e., the front side surface, instead of the upper surface, thereby suppressing increases in size and volume of the hydraulic unit 1 in the upward/downward direction. The further details will be described below.

The main reservoir tank 400 may communicate with the hydraulic block 100 through the reservoir bore 112 and supply the pressurized medium.

The master cylinder 500 connected to the brake pedal may be provided in the cylinder bore. The cylinder bore may be recessed and extended in a fifth surface 105 of the hydraulic block 100 that defines a rear side surface between the first surface 101 and the second surface 102.

The cylinder bore may be formed in the hydraulic block 100 and extend in the forward/rearward direction, and an operation axis of the master cylinder 500 may also be provided in a direction parallel to the forward/rearward direction of the hydraulic block 100. The axis of the master cylinder 500 is disposed in the direction parallel to the forward/rearward direction of the hydraulic block 100, and an axis of the motor 300 is disposed in the direction parallel to the direction of the thickness of the hydraulic block 100, such that the axis of the master cylinder 500 and the axis of the motor 300 may be orthogonal to each other, and as a result, the arrangements of the master cylinder 500 and the motor 300 of the hydraulic unit 1 may be efficiently implemented. Meanwhile, reference numeral 600 indicates a mounting bracket configured to mount the hydraulic block 100 on a vehicle body. The mounting bracket 600 is coupled to the fifth surface 105 of the hydraulic block 100 and mounted on and fixed to the vehicle body through a plurality of bolts 601, such that the hydraulic block 100 may be stably fixed to and supported on the vehicle body by means of the mounting bracket.

The electronic control unit 200 may be configured to control the operations of the motor 300 and the valves on the basis of information on the displacement of the brake pedal or information detected by various types of sensors (not illustrated).

The electronic control unit 200 may include a circuit board (not illustrated) provided on the second surface 102 of the hydraulic block 100 that is opposite to the first surface 101 on which the motor 300 is disposed, and the circuit board may be connected to the valves mounted in the valve bores and configured to receive power from a power supply part (not illustrated) or receive an electrical signal through a signal transmission part (not illustrated). In addition, the electronic control unit 200 may include a connector 210 configured to supply power to the circuit board or transmit an electrical signal to the circuit board, and a housing 220 configured to accommodate the circuit board therein and having an outer surface on which the connector 210 is provided.

The power supply part may supply power from a battery (not illustrated) of the vehicle to the circuit board. The power supply part may supply and transmit power.

The connector 210 may be positioned at an upper side of a fourth surface 104 of the housing 220 that defines an upper surface between the first surface 101 and the second surface 102 of the hydraulic block 100. In this case, as illustrated in FIG. 2, in case that the connector 210 is provided in a shape extending in one direction and has a large width 210a and a small width 210b, the large width 210a of the connector 210 may be disposed in the forward/rearward direction on the housing 220, which may suppress an increase in size of the hydraulic unit 1 in the upward/downward direction. Further, the connector 210 may be disposed at a position between an upper end of the housing 220 and the fourth surface 104 of the hydraulic block 100. That is, an arrangement height of the connector 210 is positioned between the upper end of the housing 220, which corresponds to an uppermost end of the hydraulic unit 1, and the fourth surface 104, which is the upper surface of the hydraulic block 100, which may prevent the size of the hydraulic unit 1 in the upward/downward direction from being increased by the housing 220 and the connector 210 of the electronic control unit 200.

In addition, in order to prevent a line or the like, which is connected to the connector 210, from interfering with peripheral component elements, the connector 210 may be disposed to be introduced and coupled in a direction corresponding to a direction of a thickness between the first surface 101 and the second surface 102 of the hydraulic block 100. Therefore, a line connected to the connector 210 may also be disposed between the upper end of the housing 220 and the fourth surface 104 of the hydraulic block 100, such that interference and contact between the line and peripheral component elements may be minimized, and an increase in size of the hydraulic unit 1 in the upward/downward direction may be minimized.

The housing 220 is mounted on the second surface 102 of the hydraulic block 100 and has an accommodation space for accommodating therein a controller (not illustrated) configured to control the motor 300 and the plurality of valves. In order to form the accommodation space, the housing 220 may include a housing body opened at one side thereof, and a cover coupled to the opened side of the housing body.

In general, the main reservoir tank configured to accommodate the pressurized medium is provided to extend in the upward/downward direction in an area corresponding to the third surface 103 of the hydraulic block 100 in which the reservoir bore 112 is formed. However, there occurs a problem in that the application of this structure cannot meet various needs of customers because of a lack of space during vehicle package layout processes. Meanwhile, the package layout refers to a series of engineering operations that efficiently configure and dispose the main constituent elements of the entire vehicle in consideration of various types of constraint conditions of the main constituent elements, and the package layout ensures customer comfort and optimizes convenience of use.

The main reservoir tank 400 according to the embodiment of the present disclosure may be mounted on the front surface, i.e., the third surface 103 of the hydraulic block 100 and have a ‘ [symbol] ’ shape to surround the electronic control unit 200, such that the main reservoir tank 400 is easily installed in a limited space of the vehicle.

With reference to FIG. 3, the main reservoir tank 400 according to the embodiment of the present disclosure has a ‘ [symbol] ’ shape provided to surround the electronic control unit 200, specifically, the front side surface of the housing 220 and includes a coupling part 410, a connection part 420, and an extension part 430 from below to above in a thickness direction. That is, the coupling part 410 and the extension part 430 may be connected to and communicate with each other by the connection part 420, define one space, store the pressurized medium therein, and be mounted on the third surface 103 of the hydraulic block 100.

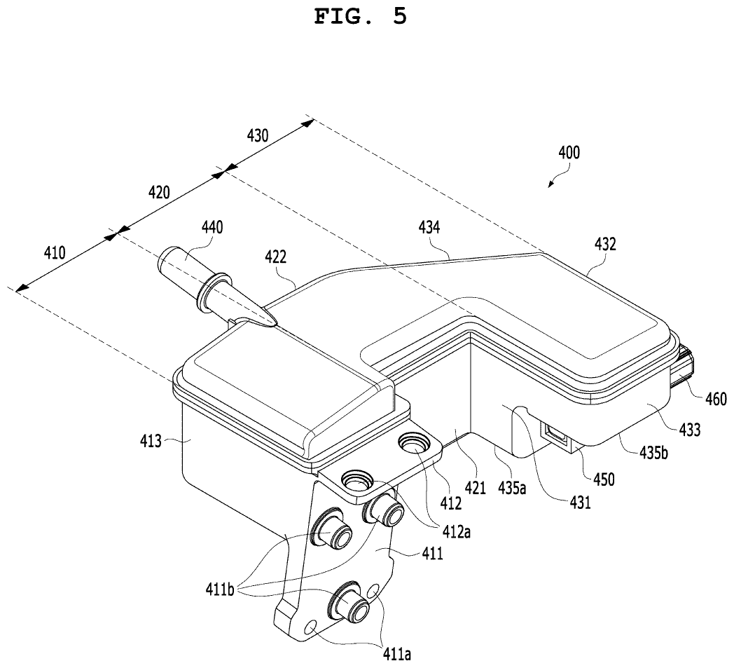

Meanwhile, FIG. 2 illustrates that the main reservoir tank 400 according to the present disclosure is mounted to be inclined toward the front side surface of the hydraulic block 100. This is a visual result obtained as the arrangement directions of the hydraulic block 100, the electronic control unit 200, and the master cylinder 500 are illustrated based on the horizontal direction. Hereinafter, a specific structure of the main reservoir tank 400 according to the embodiment of the present disclosure will be described with reference to FIGS. 5 to 7.

FIG. 5 is a perspective view illustrating the main reservoir tank according to the present embodiment.

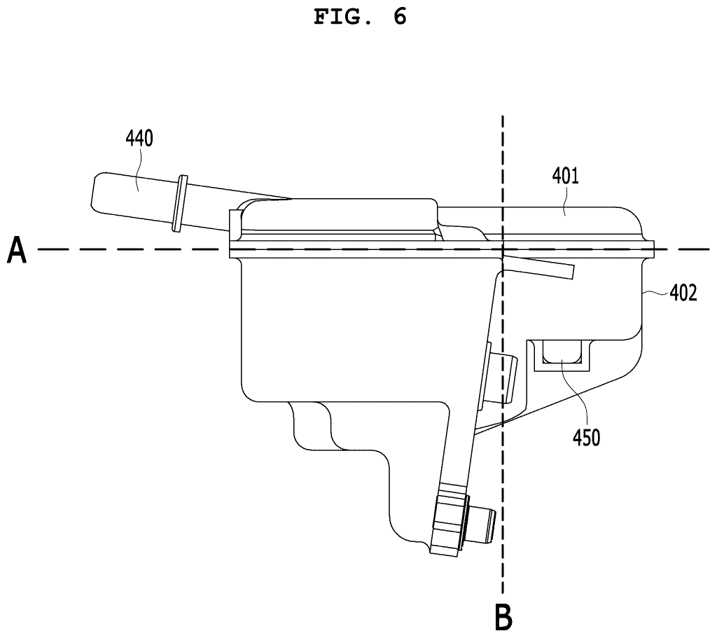

FIG. 6 is a side view illustrating the main reservoir tank according to the present embodiment.

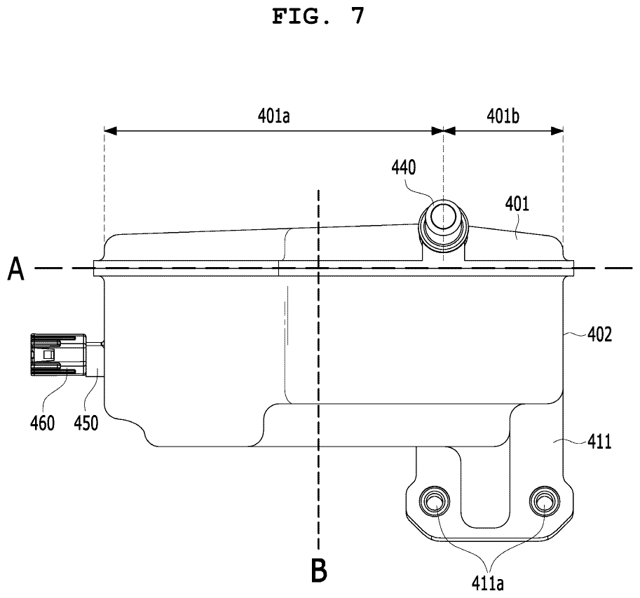

FIG. 7 is a front view illustrating the main reservoir tank according to the present embodiment.

With reference to FIGS. 5 to 7, the main reservoir tank 400 broadly includes the coupling part 410, the connection part 420, and the extension part 430. In this case, the coupling part 410, the connection part 420, and the extension part 430 are separated as three zones to describe the structure of the main reservoir tank 400. The zones are configured to substantially communicate with one another, define one accommodation space, and store the pressurized medium therein.

The coupling part 410 is provided on the third surface 103 of the hydraulic block 100 that defines the front side surface between the first surface 101 and the second surface 102, and the coupling part 410 is configured to stably couple the main reservoir tank 400 to the hydraulic block 100.

The coupling part 410 includes a first fastening portion 411, a second fastening portion 412, and a tank portion 413 provided between the first fastening portion 411 and the second fastening portion 412.

The first fastening portion 411 may protrude and extend to be bound to the third surface 103 of the hydraulic block 100 by fastening members such as bolts.

Specifically, the first fastening portion 411 may include a plurality of first fastening holes 411a provided to be penetrated by the fastening members such as bolts, and a plurality of oil ports 411b coupled to the third surface 103 of the hydraulic block 100 and configured to supply the pressurized medium.

The first fastening hole 411a may be provided at a position on a lower end of the first fastening portion 411 in order to stably couple and fix the main reservoir tank 400 to the third surface 103 of the hydraulic block 100. The drawings illustrate that two first fastening holes 411a are provided. However, the present disclosure is not necessarily limited thereto.

The oil port 411b may be integrated with the first fastening portion 411 of the main reservoir tank 400.

The oil ports 411b may be formed to correspond to the positions of the plurality of reservoir bores 112 formed in the third surface 103 of the hydraulic block 100 and supply the pressurized medium, which is accommodated in the main reservoir tank 400, to the master cylinder 500 or the hydraulic piston (not illustrated).

Meanwhile, the main reservoir tank 400 may have a main reservoir chamber (not illustrated) configured to store the pressurized medium therein, and the main reservoir chamber may be divided into a plurality of chambers by a plurality of partition walls.

The drawings illustrate that the first fastening portion 411 has three oil ports 411b. However, a specific number of oil ports 411b may correspond to the number of chambers (not illustrated) separated by the plurality of partition walls (not illustrated). In a non-restrictive example, in case that the main reservoir chamber is divided into first to third main reservoir chambers, the oil ports 411b may include a first oil port provided to communicate with the first main reservoir chamber, a second oil port provided to communicate with the second main reservoir chamber, and a third oil port provided to communicate with the third main reservoir chamber. Therefore, the pressurized medium stored in the main reservoir chambers may be introduced or discharged through the oil ports.

The first and second oil ports may be respectively connected to first and second master chambers (not illustrated) formed in the master cylinder, and the third oil port may be connected to a hydraulic piston pressure chamber (not illustrated). The connection structure is an example, and the present disclosure is not limited thereto. That is, the first and third oil ports may be connected to the master cylinder, and the second and third oil ports may be connected to the master cylinder.

Meanwhile, in case that the above-mentioned main reservoir chamber is divided into the first to third main reservoir chambers, the reservoir bores 112 may be provided as a plurality of reservoir bores 112 so that the pressurized medium smoothly flow between the first to third main reservoir chambers of the main reservoir tank 400, the pressure chamber, and the master chamber provided in the hydraulic block 100. Specifically, the reservoir bores 112 may include a first reservoir bore configured to communicate with the first master chamber to allow the chambers, which are separated in the main reservoir tank 400, to communicate with the hydraulic block 100, a second reservoir bore configured to communicate with the second master chamber, and a third reservoir bore configured to communicate with the pressure chamber. However, the connection structure is an example, and the present disclosure is not limited thereto.

The plurality of oil ports 411b formed on the first fastening portion 411 may be formed to correspond to the positions of the reservoir bores 112 of the hydraulic block 100 and correspond to the specific number of chambers defined by dividing the main reservoir chamber in the main reservoir tank 400 by the partition walls, and the plurality of oil ports 411b may be connected to the master cylinder and/or the hydraulic piston in various ways.

The plurality of oil ports 411b formed on the first fastening portion 411 communicates with the tank portion 413 so that the pressurized medium accommodated in the main reservoir tank 400 is introduced or discharged through the tank portion 413 of the coupling part 410.

As illustrated in FIGS. 2 and 4, the coupling part 410 may further include a ridge portion 414 formed to communicate with the tank portion 413 and the particular oil port in order to prevent a length of the tank portion 413 from being excessively increased in accordance with the positions at which the plurality of oil ports 411b is disposed. In this case, the two first fastening holes 411a may be provided at lower ends of two opposite sides of the ridge portion 414 in order to mount the main reservoir tank 400 on the third surface 103 of the hydraulic block. Because the ridge portion 414 is further included, a volume of the tank portion 413 may be easily adjusted.

The second fastening portion 412 may protrude and extend to be bound, by means of the fastening members, such as bolts, to the fourth surface 104 of the hydraulic block 100 that defines the upper surface between the first surface 101 and the second surface 102.

The second fastening portion 412 may include a plurality of second fastening holes 412a provided to be penetrated by the fastening members such as bolts. The drawings illustrate that two second fastening holes 412a are provided. However, the present disclosure is not necessarily limited thereto.

The coupling part 410 according to the embodiment of the present disclosure may stably fix the main reservoir tank 400 to the hydraulic block 100 by means of the first and second fastening portions 411 and 412 respectively provided on surfaces perpendicular to each other, and the coupling part 410 may accommodate the pressurized medium by maximally using the front surface space of the hydraulic block 100, which is advantageous in spatial utilization and accommodation capacity of the pressurized medium.

With reference to FIGS. 6 and 7, the main reservoir tank 400 may be formed by coupling a main upper body 401 and a main lower body 402. In case that an axis, which passes through a horizontal plane that adjoins a lower surface of the main upper body 401 and an upper surface of the main lower body 402, refers to a horizontal axis A and an axis defined to be perpendicular to the horizontal axis A refers to a vertical axis B, the first fastening portion 411 may be formed to be inclined at a predetermined angle toward a front side of the hydraulic block based on the vertical axis B. Therefore, the plurality of hydraulic pressure ports 411b formed on the first fastening portion 411 may also be formed to be inclined downward based on the vertical axis B, such that the pressurized medium may be more easily supplied. Although not illustrated, the plurality of reservoir bores 112 formed in the hydraulic block 100 may also be formed to have a predetermined inclination angle so that the plurality of reservoir bores 112 may be connected to the hydraulic pressure ports 411b while corresponding to the direction in which the hydraulic pressure ports 411b are inclined.

The tank portion 413 is provided between the first fastening portion 411 and the second fastening portion 412 and disposed to adjoin the third surface 103 of the hydraulic block 100. The tank portion 413 may communicate with the connection part 420 and the extension part 430, which will be described below, define one space, and accommodate the pressurized medium therein. The details will be described below.

The extension part 430 is provided to extend in a direction corresponding to the longitudinal direction of the housing 220 of the electronic control unit 200.

Specifically, the extension part 430 is formed to extend from the third surface 103, which is the front side of the hydraulic block 100, to the fifth surface 105 that is the rear side of the hydraulic block 100. Meanwhile, the fifth surface 105 has the cylinder bores and is the surface of the hydraulic block 100 that defines the rear side surface between the first surface 101 and the second surface 102.

The extension part 430 is provided to be spaced apart from the housing 220 of the electronic control unit 200 at a predetermined interval.

The extension part 430 may include an inner surface 431 formed to be parallel to the housing 220 and adjacent to the housing 220, an outer surface 432 formed to be spaced apart from the inner surface 431 in the thickness direction of the electronic control unit 200 or the housing 220, a first connection surface 433 configured to connect the inner surface 431 and the outer surface 432, and a second connection surface 434 formed to be opposite to the first connection surface 433.

That is, the configuration in which the extension part 430 is spaced apart from the housing 220 of the electronic control unit 200 at a predetermined interval means that the predetermined interval is formed between the inner surface 431 of the extension part 430 and the housing 220, and the outer surface 432 is a surface directed outward. In this case, the outer surface 432 refers to a surface opposite to the inner surface 431, i.e., a surface directed in the upward direction based on FIG. 3.

The extension part 430 is surrounded by the inner surface 431, the outer surface 432, the first connection surface 433, and the second connection surface 434 and stores the pressurized medium in an internal space formed to be sealed by an upper body and a bottom surface 435 that will be described below.

An accommodation portion 450 may be provided in a lower portion of the extension part 430 of the main reservoir tank 400 according to the embodiment of the present disclosure.

Specifically, based on the upper surface of the main lower body 402, the bottom surface 435 of the extension part 430 may include a first bottom surface 435a having a first depth, and a second bottom surface 435b having a second depth. The first depth may be larger than the second depth. The accommodation portion 450 may be provided at a lower end of the second bottom surface 435b and include a detection part (not illustrated) and a warning lamp light switch 460.

The detection part (not illustrated) may identify the amount of pressurized medium in the main reservoir tank 400 by detecting a level of the pressurized medium accommodated in the main reservoir chamber in the main reservoir tank 400. The detection part may be accommodated in the accommodation portion 450 and detect whether the amount of pressurized medium is a predetermined level or lower in accordance with an upward/downward movement of a float provided in the main reservoir tank 400.

The warning lamp light switch 460 is accommodated in the accommodation portion 450 and configured to raise a warning to a driver in response to a signal detected by the detection part. That is, in case that the level of the pressurized medium accommodated in the main reservoir tank 400 is a predetermined level or lower, a warning may be raised to the driver by operating the warning lamp light switch 460 and turning on a warning lamp on a display part in the vehicle.

The warning lamp light switch 460 may be provided on the outer surface 432 of the extension part 430 and directed to the outside. In this case, the outside refers to a surface directed upward based on FIG. 3.

In the main reservoir tank 400 according to the embodiment of the present disclosure, the warning lamp light switch 460, which is directed toward the outside of the outer surface 432, is accommodated in the accommodation portion 450 provided at the lower end of the extension part 430, such that the spatial utilization may be ensured, and particularly, a space constraint may be reduced during the vehicle package layout process, which may implement package layouts in more efficient and various ways.

The connection part 420 allows the coupling part 410 and the extension part 430 to communicate with each other and is provided to be parallel to the front side surface of the housing 230.

The connection part 420 is provided to be spaced apart from the front side surface of the housing 230 at a predetermined interval.

The connection part 420 may include an inner connection surface 421 formed adjacent to the front side surface of the housing 230, and an outer connection surface 422 opposite to the inner connection surface 421.

That is, the tank portion 413 of the coupling part 410 may be implemented to have a structure connected inward to the inner connection surface 421 of the connection part 420 and the inner surface 431 of the extension part 430 and having a ‘ [symbol] ’ shape that surrounds the electronic control unit 200. Meanwhile, the drawings illustrate that the outer connection surface 422 of the connection part 420 is formed obliquely on a planar structure with respect to the second connection surface 434 of the extension part 430. However, the outer connection surface 422 is not necessarily formed as described above.

The main reservoir tank 400 having the ‘ [symbol] ’ shape may be formed by coupling the main upper body 401 having a ‘ [symbol] ’ shape and the main lower body 402 having a ‘ [symbol] ’ shape. That is, the coupling part 410, the connection part 420, and the extension part 430 may be related to the main lower body 402, and the main upper body 401 may be provided to fit the shape of the main lower body 402 provided in accordance with the specific shapes of the coupling part 410, the connection part 420, and the extension part 430.

The main reservoir chamber (not illustrated), which is the space in the main reservoir tank 400, is formed by coupling the main upper body 401 and the main lower body 402, and the pressurized medium is stored in the main reservoir chamber. The main reservoir chamber may be connected to the master cylinder 500 or the hydraulic piston (not illustrated) through the reservoir bore 112 formed in the hydraulic block 100.

The main upper body 401 includes a first connection port 440.

The first connection port 440 may be configured to receive the pressurized medium from a remote reservoir tank 700 to be described below, and the first connection port 440 may be integrated with the main upper body 401. Specifically, the first connection port 440 may be provided at a location adjacent to the main upper body 401 corresponding to the coupling part 410 and the connection part 420.

With reference to FIG. 6, the first connection port 440 may be provided to be inclined toward the lower surface of the main upper body 401, i.e., inclined upward based on the horizontal axis A. In this case, a large inclination angle is advantageous in discharging air, but the first connection port 440 may be formed to have an inclination angle of 60° or less based on the horizontal axis A in terms of spatial utilization.

Air may be introduced into the brake system as air is introduced during a process of supplying the pressurized medium from the remote reservoir tank 700 or air is exposed to the oil port 411b through which the pressurized medium is introduced or discharged. Because the introduction of air eventually causes deteriorations in pedal feel and brake performance, the prevention of the introduction of air into the brake system is important in terms of braking performance.

The first connection port 440 according to the embodiment of the present disclosure is provided to have a predetermined inclination angle based on the horizontal axis A, such that the air present in the main reservoir tank 400 may pass through a connection member 800, which will be described below, in a direction of the first connection port 440 and be guided to be discharged toward an injection part 710 of the remote reservoir tank 700.

The upper surface of the main upper body 401 may include first and second sections 401a and 401b formed to be inclined toward two opposite ends based on the first connection port 440. Specifically, the first section 401a may be the upper surface of the main upper body 401 corresponding to the connection part 420 and the extension part 430, and the second section 401b may be the upper surface of the main upper body 401 corresponding to the coupling part 410.

In order to maximize the effect of discharging air, the first section 401a according to the embodiment of the present disclosure may have a first inclination angle so that air is discharged from one end of the main upper body 401 to the first connection port 440, and the second section 401b may have a second inclination angle so that air is discharged from the other end of the main upper body 401 to the first connection port 440.

The first inclination angle and the second inclination angle may be equal to each other. The inclination angle may be 60° or less in order to easily discharge air without increasing a volume of the main reservoir tank 400 in accordance with an increase in height of the main upper body 401.

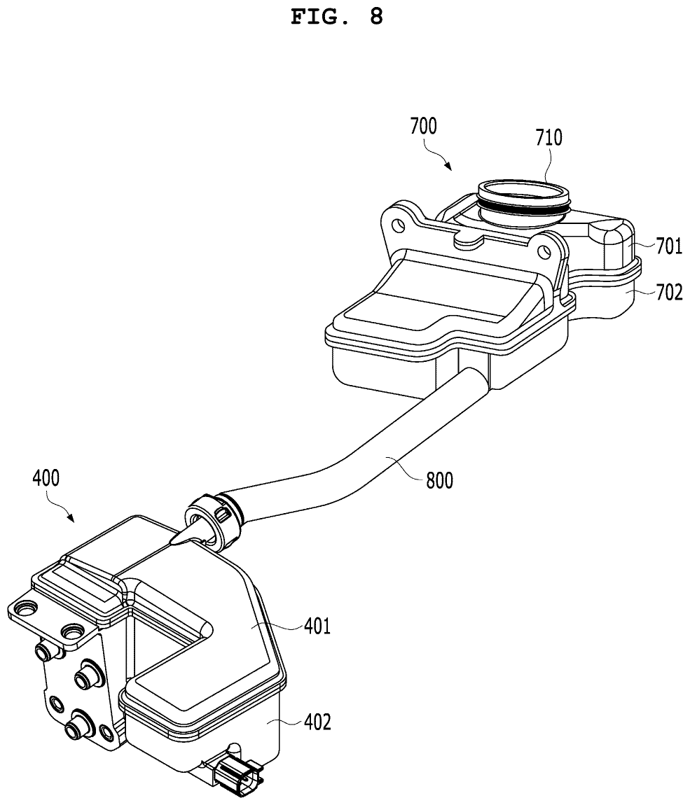

FIG. 8 is a view illustrating a structure in which the main reservoir tank according to the present embodiment is connected to the remote reservoir tank.

With reference to FIG. 8, the hydraulic unit 1 according to the embodiment of the present disclosure may further include the remote reservoir tank 700 connected to the main reservoir tank 400 and configured to store the pressurized medium therein.

The remote reservoir tank 700 supplies the pressurized medium to the main reservoir tank 400 through the above-mentioned first connection port 440.

The remote reservoir tank 700 may be provided to be spaced apart from an upper side of the main reservoir tank 400 at a predetermined interval.

The remote reservoir tank 700 may include the injection part 710 configured to inject the pressurized medium, and a second connection port (not illustrated) configured to supply the pressurized medium injected into the main reservoir tank 400.

A remote reservoir chamber (not illustrated) is provided in the remote reservoir tank 700 and stores the pressurized medium. The remote reservoir chamber is a space formed in the remote reservoir tank 700 when a remote upper body 701 and a remote lower body 702 of the remote reservoir tank 700 are coupled. Therefore, the remote reservoir chamber may store the pressurized medium to be supplied to the main reservoir tank 400.

The injection part 710 may be provided on the remote upper body 701, and the second connection port may be provided on the remote lower body 702. The remote upper body 701 and the remote lower body 702 may be integrated by being coupled by thermal bonding.

The injection part 710 is formed at an upper side of the remote upper body 701, and the pressurized medium is introduced through the injection part 210. In this case, a cap may be installed on the injection part 710 and prevent the pressurized medium from leaking to the outside.

The second connection port may be integrated with the remote lower body 702. The second connection port may be connected to the first connection port 440 by the connection member 800 to be described below. In this case, the remote reservoir tank 700 may be provided at a position higher than the main reservoir tank 400, such that the pressurized medium may be easily transferred to the main reservoir tank 400.

One end of the connection member 800 is connected to the first connection port 440, and the other end of the connection member 800 is connected to the second connection port, such that the pressurized medium in the remote reservoir tank 700 is transferred to the main reservoir tank 400. The connection member 800 may be provided as a rubber hose so that the pressurized medium is easily transferred even though the installation position of the remote reservoir tank 700 or the main reservoir tank 400 is selectively changed.

A plurality of guide walls (not illustrated) may be provided in the remote reservoir tank 700 in order to increase flow resistance of the pressurized medium guided to the second connection port. The guide walls may extend in a perpendicular direction from a bottom surface of the remote reservoir tank 700.

In the hydraulic unit 1 and the brake system including the same according to the present embodiment described above, the main reservoir tank 400 has the ‘ [symbol] ’ shape formed to surround the electronic control unit 200, which may meet various needs of customers during the vehicle package layout processes. Further, the inclination angle is applied to the main reservoir tank 400, such that the introduction of air into the brake system may be effectively prevented, and the braking performance may be improved. Moreover, the hydraulic unit 1 and the brake system including the same according to the present embodiment may perform various functions and ensure compact size and volume, which may improve the degree of design freedom and spatial utilization of the vehicle.

What is claimed is:

1. A hydraulic unit comprising:
a main reservoir tank configured to accommodate a pressurized medium;
a hydraulic block having a reservoir bore configured to communicate with the main reservoir tank, a cylinder bore in which a master cylinder connected to a brake pedal is provided, a motor bore in which a motor configured to generate liquid pressure by being operated by an electrical signal outputted in response to a displacement of the brake pedal is provided, a hydraulic flow path, and a valve bore in which a valve configured to control a flow of the pressurized medium through the hydraulic flow path is provided; and
an electronic control unit configured to control operations of the motor and the valve on the basis of information on the displacement of the brake pedal,
wherein the motor bore is provided on a first surface of the hydraulic block,
wherein a housing of the electronic control unit is provided on a second surface of the hydraulic block that is a surface opposite to the first surface,
wherein the main reservoir tank comprises:
a coupling part provided on a third surface that defines a front side surface between the first surface and the second surface;
an extension part provided in a direction corresponding to a longitudinal direction of the housing; and
a connection part configured to allow the coupling part and the extension part to communicate with each other, and is provided to surround a front side surface of the housing.

2. The hydraulic unit of claim 1, wherein the coupling part comprises:
a first fastening portion coupled to the third surface of the hydraulic block;
a second fastening portion coupled to a fourth surface that defines an upper surface between the first surface and the second surface of the hydraulic block; and
a tank portion provided between the first fastening portion and the second fastening portion.

3. The hydraulic unit of claim 2, wherein the extension part is provided to be spaced apart from the housing at a predetermined interval.

4. The hydraulic unit of claim 3, wherein the connection part is provided to be spaced apart from the front side surface of the housing at a predetermined interval.

5. The hydraulic unit of claim 1, wherein the main reservoir tank is formed by coupling a main upper body and a main lower body.

6. The hydraulic unit of claim 5, further comprising:
a remote reservoir tank configured to store the pressurized medium therein,
wherein the main upper body comprises a first connection port configured to receive the pressurized medium from the remote reservoir tank.

7. The hydraulic unit of claim 6, wherein an upper surface of the main upper body comprises first and second sections respectively formed to be inclined toward two opposite ends based on the first connection port.

8. The hydraulic unit of claim 7, wherein the first section has a first inclination angle so that air is discharged from one end of the main upper body to the first connection port, and
wherein the second section has a second inclination angle so that air is discharged from the other end of the main upper body to the first connection port.

9. The hydraulic unit of claim 6, wherein the first connection port is provided to be inclined upward based on a lower surface of the main upper body.

10. The hydraulic unit of claim 5, wherein the main lower body comprises a plurality of oil ports coupled to the third surface of the hydraulic block and configured to supply the pressurized medium.

11. The hydraulic unit of claim 6, wherein the remote reservoir tank comprises:
an injection part configured to inject the pressurized medium; and
a second connection port configured to supply the pressurized medium to the main reservoir tank, and
wherein the pressurized medium is stored in the remote reservoir tank.

12. The hydraulic unit of claim 11, further comprising:
a connection member configured to connect the first connection port and the second connection port so that the pressurized medium in the remote reservoir tank is transferred to the main reservoir tank.

13. The hydraulic unit of claim 5, wherein the main reservoir tank comprises:
a main reservoir chamber configured to store the pressurized medium therein; and
at least one partition wall provided to divide the main reservoir chamber into a plurality of chambers.

14. The hydraulic unit of claim 13, wherein the main lower body comprises an accommodation portion configured to accommodate a detection part configured to detect a level of the pressurized medium accommodated in the main reservoir chamber, and a warning lamp light switch provided to raise a warning to a driver on the basis of a signal detected by the detection part.

15. The hydraulic unit of claim 1, wherein the reservoir bore is provided in the third surface of the hydraulic block.

16. The hydraulic unit of claim 1, wherein the cylinder bore is provided in a fifth surface of the hydraulic block that defines a rear side surface between the first surface and the second surface.

17. The hydraulic unit of claim 1, wherein the valve bore is provided in the second surface of the hydraulic block.

18. The hydraulic unit of claim 1, wherein the electronic control unit comprises a connector configured to supply power to a circuit board or transmit an electrical signal, and
wherein the connector is positioned at an upper side of a fourth surface of the hydraulic block that defines an upper surface between the first surface and the second surface.

19. A hydraulic unit comprising:
a master cylinder connected to a brake pedal;
a hydraulic block having a plurality of hydraulic flow paths and configured such that the master cylinder is mounted on the hydraulic block;
an electronic control unit installed on a side surface of the hydraulic block and configured to control operations of a motor and a valve mounted on the hydraulic block; and
a main reservoir tank mounted on a front surface of the hydraulic block and having a ‘ [symbol] ’ shape formed to surround the electronic control unit,
wherein the main reservoir tank accommodates a pressurized medium therein and comprises a plurality of chambers separated by a plurality of partition walls.
